(19) United States
(12) Patent Application Publication
(10) Pub. No.: US 2010/0161442 A1
(43) Pub. Date: Jun. 24, 2010

(54) Interactive Electronic Trading Method

(76) Inventor: Cheng-Han Kuo, Tainan City (TW)

Correspondence Address: Dr. BANGER SHIA;Patent Office of Bang Shia, 102 Lindencrest Ct, Sugar Land, TX, 77479-5201, US

(21) Appl. No.: 12/390,427

(22) Filed: Feb. 21, 2009

(30) Foreign Application Priority Data
Dec. 22, 2008 (TW) 097222924

(51) Int. Cl. G06Q 30/00; G06Q 10/00

(52) U.S. Cl. 705/26; 705/400; 705/30

(57) ABSTRACT

An interactive electronic trading method includes an Internet electronic commerce agent obtaining sales agency in a virtual channel from a commodity supplier. The Internet electronic commerce agent or its subnetwork agent places the commodity on a sales platform that publishes information of the commodity and establishes an ownership unit price for each of a plurality of ownership units of the commodity obtained by dividing a target price of the commodity. A plurality of consumers purchases one or more ownership units of the commodity on the sales platform. Each ownership unit has a purchase parameter. The sales platform chooses the owner of the commodity when the accumulated amount is equal to the target price, and trade of the commodity is completed. The sales platform chooses the owner according to the purchase parameters. The sales platform refunds or reserves the money of the consumers when the trade is not completed due to the accumulated amount is lower than the target price or due to other reasons.

### BACKGROUND OF THE INVENTION

1. Field of the Invention

The present invention relates to an electronic trading method and, more particularly, to an interactive electronic trading method that can increase the transaction rate of commodities.

2. Description of the Related Art

Since distance is not a limitation to the Internet, many commodities utilize the Internet as a sales channel to increase the sales. In conventional transaction methods on the Internet, the sellers place the commodities on the network and provide the information of the commodities including the specifications, functions, prices, etc. The consumers can place an order for the commodities on the sales platform. Furthermore, bidding or bargaining can be done through the network.

In the conventional network transaction methods, the consumers have to pay the label price or the highest bid or the price after bargaining to get the commodities. However, in some cases, the commodities having high prices can not be sold easily, such that the transaction rate is low and that the consumers can not own the commodities no matter how much they love the commodities.

### BRIEF SUMMARY OF THE INVENTION

An objective of the present invention is to provide an interactive electronic trading method that increases the transaction rate to enhance economical development while providing the consumers with a chance to own the commodities at an acceptable price.

An interactive electronic trading method according to the preferred teachings of the present invention includes an Internet electronic commerce agent obtaining sales agency in a virtual channel from a supplier of a commodity. The Internet electronic commerce agent or a subnetwork agent of the Internet electronic commerce agent places the commodity on a sales platform. Information of the commodity is published on the sales platform. An ownership unit price for each of a plurality of ownership units of the commodity corresponding to a target price of the commodity is established by the sales platform. The ownership unit price is obtained by dividing the target price. A plurality of consumers purchases one or more ownership units of the commodity on the sales platform. Each ownership unit has a purchase parameter. The sales platform chooses the owner of the commodity when the accumulated amount is equal to the target price, and trade of the commodity is completed. The sales platform chooses the owner according to the purchase parameters. The sales platform refunds or reserves the money of the consumers when the trade is not completed due to the accumulated amount is lower than the target price or due to other reasons.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows connection between a network sales platform and computers of consumers for carrying out an interactive electronic trading method according to the preferred teachings of the present invention.

FIG. 2 shows a flowchart of the interactive electronic trading method according to the preferred teachings of the present invention.

FIG. 3 shows an example of published information of a commodity.

FIG. 4 shows an example of a published order record and decision of the ownership of the commodity.

### DETAILED DESCRIPTION OF THE INVENTION

An interactive electronic trading method according to the preferred teachings of the present invention includes an Internet electronic commerce agent obtaining sales agency in a virtual channel from a supplier of a commodity. The Internet electronic commerce agent or a subnetwork agent of the Internet electronic commerce agent places the commodity on a sales platform.

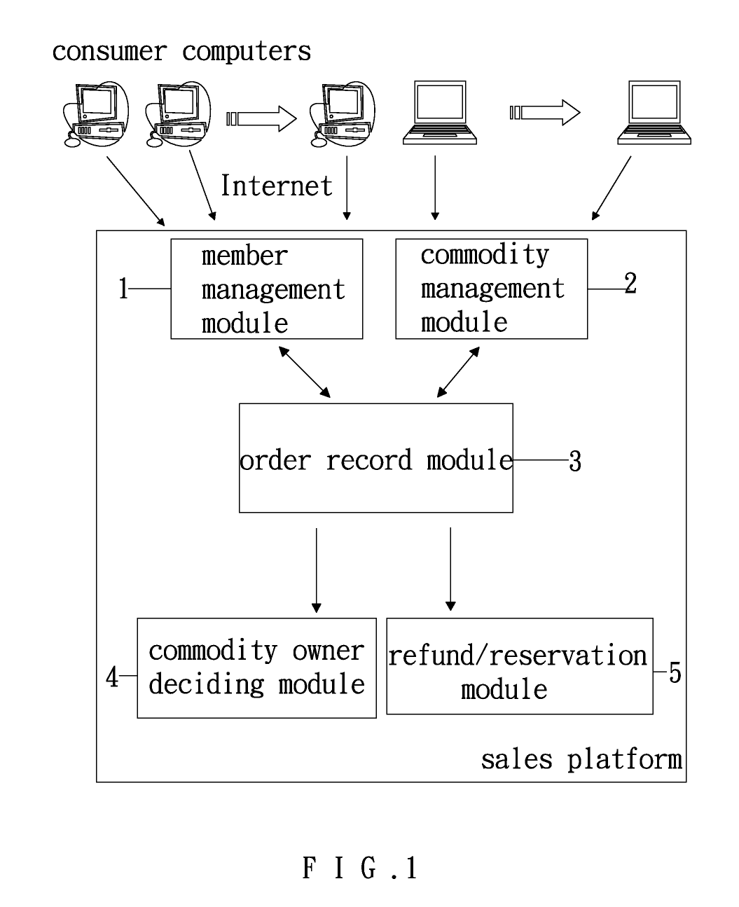

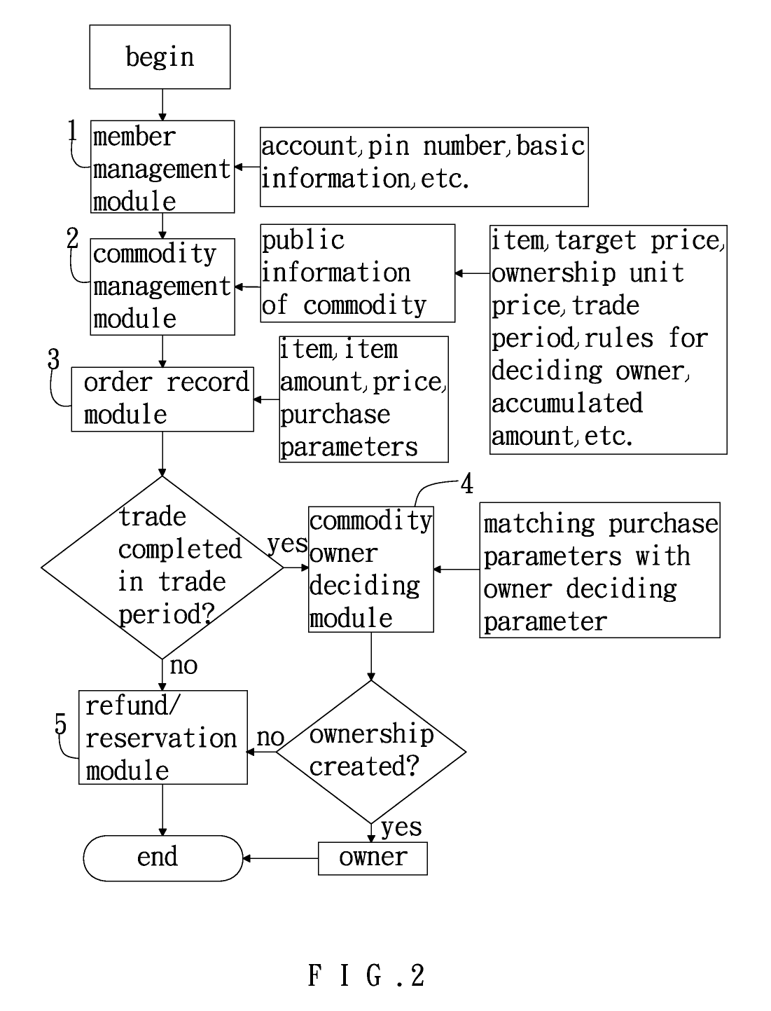

With reference to FIGS. 1 and 2, the sales platform includes a member management module 1, a commodity management module 2, an order record module 3, a commodity owner deciding module 4, and a refund/reservation module 5. The member management module 1 includes a database containing a member account, a pin number, a name, and information relating to an identity of each of a plurality of consumers inputted by each consumer through his or her computer.

The commodity management module 2 provides public information of the commodity including the item, the target price, the ownership unit price, the trade period, the rules for deciding the owners, and the accumulated amount. The ownership of the commodity is divided into a plurality of ownership units by dividing the target price, so that a price for each ownership unit is established.

The order record module 3 includes serial numbers, names of the members, times of purchase, purchase amounts, the accumulated amount, the ownership units purchased, and purchase parameters.

The commodity owner deciding module 4 decides an owner deciding parameter based on the rules for deciding the owners. The owner deciding parameter can be a parameter obtained by a public lottery or a published, decided indexes of a country, such as a lottery wining combination, a Dow-Jones average index, a Japanese stock market index, a Taiwan stock market index, etc. The commodity owner deciding module 4 matches the owner deciding parameter with the purchase parameters to decide the final owner of the commodity.

When the trade is not completed, the sales platform utilizes the refund/reservation module 5 to refund the consumers or reserve the money of the consumers for purchasing another commodity on the sales platform according to decision by the consumers.

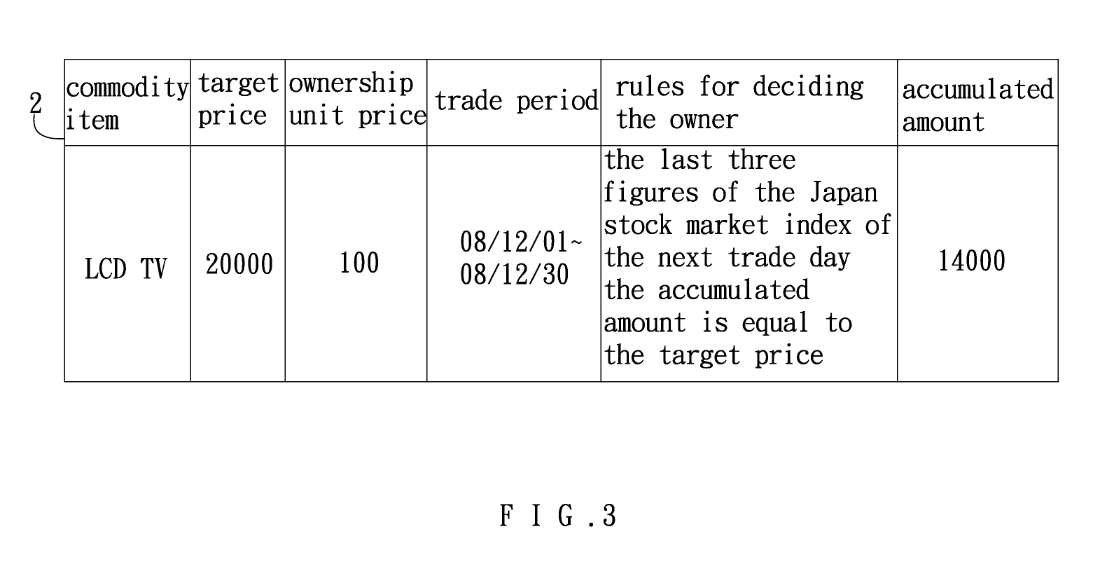

With reference to FIGS. 2-4, the consumers use their computers to input their accounts, pin numbers, and basic information relating to their identities through the Internet to the member management module 1 of the sales platform of the electronic commerce agent and become the members. The commodity management module 2 of the sales platform lists the public information of the licensed commodity including the item, the target price, the ownership unit price, the trade period, the rules for deciding the owner, the accumulated amount, etc. In an example shown in FIG. 3, the commodity item is LCD TV, the target price is NT$20,000, the ownership unit price is NT$100, the trade period of time is Dec. 1, 2008 to Dec. 30, 2008, the owner is decided by the last three figures of the Japan stock market index of the next trade day the accumulated amount of money is equal to the target price, and the accumulated amount is NT$14,000. The owner can be decided by other numbers or figures or by other methods, including but not limited to a lottery wining combination, the stock market index of any country, public lot, or other fair methods.

After obtaining the membership, the consumers can purchase one or more ownership units according to the public commodity information and input their purchase parameters to the order record module 3 of the sales platform. The purchase parameters can be inputted by the consumers or selected from a plurality of figures provided by the sales platform. Preferably, the purchase parameters of the ownership units are different from one another. Namely, the purchase parameters of the ownership units are not repeated. Specifically, if a consumer inputs a purchase parameter that has been used, the sales platform will reject it and ask the consumer to enter a new purchase parameter. However, the purchase parameters do not have to be different. In this case, if several consumers use the same purchase parameter that is identical to the owner deciding parameter, the sales platform can select one of the consumers as the owner of the commodity according to an agreed method.

Furthermore, the sales platform provide the consumers with a commodity owner agreement before the consumers place their orders to make sure that the consumers agree the rules for deciding the owner provided by the sales platform of the electronic commerce agent. The order record module 3 of the sales platform publishes the orders. When the target price of the commodity is reached within the trade period, the commodity owner deciding module matches the purchase parameters with the owner deciding parameter to decide the owner.

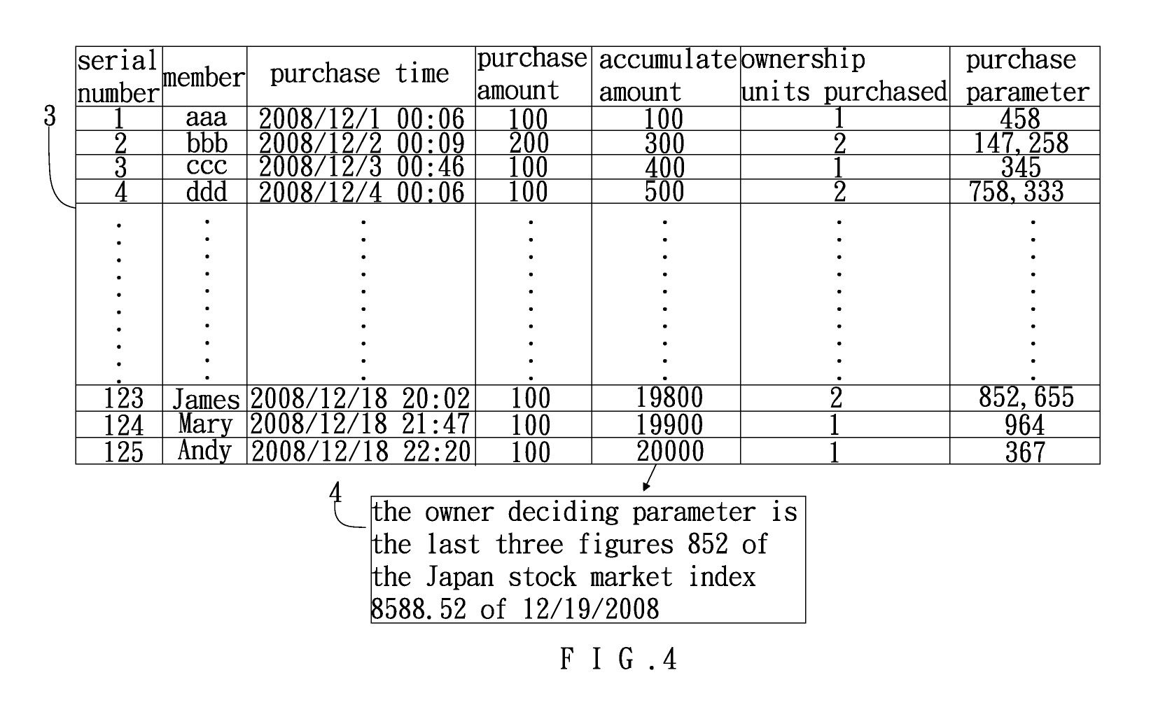

With reference to FIG. 4, the information published by the order record module 3 includes serial numbers, the names of the members, the purchase times, the purchase amounts, the accumulated amount, the ownership units purchased, and the purchase parameters. The purchase parameters are different from one another. Thus, the consumers buying more ownership units have a greater chance to become the owner of the commodity. In the example shown in FIG. 4, members bbb, ddd, and James each buys two ownership units and, thus, has two purchase parameters. Their chance is greater than others buying only one ownership unit. The accumulate amount reaches the target price NT$20,000 on Dec. 18, 2008. The owner deciding parameter is the last three figure of the Japan stock market index of Dec. 19, 2008. The Japan stock market index of Dec. 19, 2008 is 8588.52, so the owner deciding parameter is 852. Thus, member James is the final owner of the commodity. If no purchase parameter matches with the owner deciding parameter, the owner can be the member having a purchase parameter closest to the ownership deciding parameter. However, the owner of the commodity can be decided by other suitable methods.

With reference to FIG. 4, when the trade is not completed, the sales platform utilizes the refund/reservation module 5 to refund the consumers or reserve the amount of money of the consumers for purchasing another commodity on the sales platform according to decision made by the consumers.

The interactive electronic commerce trading method according to the preferred teachings of the present invention can significantly increase the transaction rate and provide an ordinary consumer with a chance to buy an expensive commodity with a low price. The consumers will have higher desires to purchase the commodity. Thus, consumption is stimulated, and the commodity flow and economic development can be enhanced.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An interactive electronic trading method comprising:
an Internet electronic commerce agent obtaining sales agency in a virtual channel from a supplier of a commodity;
the Internet electronic commerce agent or a subnetwork agent of the Internet electronic commerce agent placing the commodity on a sales platform;
publishing information of the commodity on the sales platform and establishing a ownership unit price for each of a plurality of ownership units of the commodity corresponding to a target price of the commodity, with the ownership unit price being obtained by dividing the target price;
a plurality of consumers purchasing one or more ownership units of the commodity on the sales platform, with each of the ownership units having a purchase parameter;
the sales platform choosing the owner of the commodity when an accumulated amount is equal to the target price of the commodity and completing trade of the commodity, with the sales platform choosing the owner according to the purchase parameters, with the sales platform refunding or reserving the money of the plurality of consumers when the trade is not completed due to the accumulated amount is lower than the target price or due to other reasons.

2. The interactive electronic trading method as claimed in claim 1, with the purchase parameters being decided by the plurality of consumers.

3. The interactive electronic trading method as claimed in claim 2, with the sales platform establishing rules for deciding the owner, with the rules creating an owner deciding parameter, with the owner deciding parameter being matched with the purchase parameters to decide the final owner of the commodity.

4. The interactive electronic trading method as claimed in claim 3, with the sales platform including a member management module, a commodity management module, an order record module, a commodity owner deciding module, and a refund/reservation module.

5. The interactive electronic trading method as claimed in claim 4, with the member management module including a member account, a pin number, a name, and information relating to an identity of each of the plurality of consumers inputted by each of the plurality of consumers.

6. The interactive electronic trading method as claimed in claim 4, with the commodity management module providing public information of the commodity including an item, the target price, the ownership unit price, a trade period, the rules for deciding the owner, and the accumulated amount.

7. The interactive electronic trading method as claimed in claim 4, with the order record module including serial numbers, names of the members, times of purchase, purchase amounts, the accumulated amount, the ownership units purchased, and the purchase parameters.

8. The interactive electronic trading method as claimed in claim 4, with the commodity owner deciding module matching the owner deciding parameter with the purchase parameters to decide the final owner of the commodity.

9. The interactive electronic trading method as claimed in claim 8, with the owner deciding parameter being a parameter obtained by a public lottery or a published, decided index of a country.

10. The interactive electronic trading method as claimed in claim 4, wherein when the trade is not completed, the sales platform utilizes the refund/reservation module to refund the plurality of consumers or reserve the money of the plurality of consumers for purchasing another commodity according to decision by the plurality of consumers.
